(19) United States
(12) Patent Application Publication
(10) Pub. No.: US 2013/0286931 A1
(43) Pub. Date: Oct. 31, 2013

(54) METHOD AND DEVICE FOR TRANSMITTING AN UPLINK SIGNAL FROM A RELAY NODE TO A BASE STATION IN A WIRELESS COMMUNICATION SYSTEM

(71) Applicants: Seungmin Lee, Anyang-si (KR); Kijun Kim, Anyang-si (KR); Hakseong Kim, Anyang-si (KR)

(72) Inventors: Seungmin Lee, Anyang-si (KR); Kijun Kim, Anyang-si (KR); Hakseong Kim, Anyang-si (KR)

(73) Assignee: LG ELECTRONICS INC., Seoul (KR)

(21) Appl. No.: 13/885,154

(22) PCT Filed: Aug. 24, 2011
(86) PCT No.: PCT/KR2011/006244

§ 371 Date: Jul. 11, 2013

Related U.S. Application Data
(60) Provisional application No. 61/424,037, filed on Dec. 16, 2010.

(51) Int. Cl. H04W 72/04

(52) U.S. Cl. CPC H04W 72/0413
USPC 370/315

(57) ABSTRACT

The present application discloses a method for transmitting an uplink signal from a relay node to a base station in a wireless communication system. In detail, the method comprises the steps of: setting backhaul uplink subframes on the basis of a plurality of pieces of subframe setting information received from the base station; and transmitting the uplink signal to the base station on the basis of an uplink grant in a particular backhaul uplink subframe among the set backhaul uplink subframes, wherein the uplink grant is received at a backhaul downlink subframe which exists within a preset period of time (T) from the particular backhaul uplink subframe, and the backhaul downlink subframes is not an access downlink subframe.

### TECHNICAL FIELD

The present invention relates to a wireless communication system, and more particularly, to a method for transmitting an uplink signal from a relay node to a base station in a wireless communication system, and an apparatus for the same.

### BACKGROUND ART

A 3^{rd} generation partnership project long term evolution (3GPP LTE) (hereinafter, referred to as ‘LTE’) communication system which is an example of a wireless communication system to which the present invention can be applied will be described in brief.

FIG. 1 is a diagram illustrating a network structure of an Evolved Universal Mobile Telecommunications System (E-UMTS) which is an example of a mobile communication system. The E-UMTS is an evolved version of the conventional UMTS, and its basic standardization is in progress under the 3rd Generation Partnership Project (3GPP). The E-UMTS may also be referred to as a Long Term Evolution (LTE) system. For details of the technical specifications of the UMTS and E-UMTS, refer to Release 7 and Release 8 of “3rd Generation Partnership Project; Technical Specification Group Radio Access Network”.

Referring to FIG. 1, the E-UMTS includes a User Equipment (UE), a base station (eNode B; eNB), and an Access Gateway (AG) which is located at an end of a network (E-UTRAN) and connected to an external network. Generally, the base station may simultaneously transmit multiple data streams for a broadcast service, a multicast service and/or a unicast service.

One or more cells may exist for one base station. One cell is set to one of bandwidths of 1.25, 2.5, 5, 10, and 20 MHz to provide a downlink or uplink transport service to several user equipments. Different cells may be set to provide different bandwidths. Also, the base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic can be used between the base stations. An interface for transmitting user traffic or control traffic may be used between the base stations. A Core Network (CN) may include the AG and a network node or the like for user registration of the user equipment UE. The AG manages mobility of the user equipment UE on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure, open type interface, proper power consumption of the user equipment, etc. are required.

### DISCLOSURE

### Technical Problem

Based on aforementioned discussion, an object of the present invention devised to solve the conventional problem is to provide a method for transmitting an uplink signal from a relay node to a base station in a wireless communication system, and an apparatus for the same.

### Technical Solution

In one aspect of the present invention, a method for transmitting an uplink signal from a relay node to a base station in a wireless communication system comprises the steps of configuring backhaul uplink subframes on the basis of a plurality of kinds of subframe configuration information received from the base station; and transmitting the uplink signal to the base station on the basis of an uplink grant for a specific one of the configured backhaul uplink subframes, wherein the uplink grant is received for a backhaul downlink subframe which exists within a previously set period of time (T) from the specific backhaul uplink subframe, and the backhaul downlink subframes is not an access downlink subframe.

In another aspect of the present invention, a relay node in a wireless communication system comprises a reception module configured to receive a plurality of kinds of subframe configuration information received from a base station; a processor configured to configure backhaul uplink subframes on the basis of the plurality of kinds of subframe configuration information; and a transmission module configured to transmit an uplink signal to the base station on the basis of an uplink grant for a specific one of the configured backhaul uplink subframes, wherein the uplink grant is received for a backhaul downlink subframe which exists within a previously set period of time (T) from the specific backhaul uplink subframe, and the backhaul downlink subframes is not an access downlink subframe.

Preferably, the plurality of kinds of subframe configuration information includes first information on the backhaul downlink subframes configured by the base station, second information on subframes for removing interference occurring in a pico cell, and third information on UL standalone subframes configured by the base station.

More preferably, the configured backhaul uplink subframes include subframes delayed as much as 4 subframe unit after the access downlink subframes and subframes indicated by the second information are excluded from subframes indicated by the first information, and further include subframes indicated by the third information.

Also, the access downlink subframes are those of indexes #(0), #(4), #(5) and #(9).

Moreover, if the specific backhaul uplink subframe is the subframe of index #(n) indicated by the third information, the uplink grant is transmitted from the base station to the relay node for a backhaul downlink subframe existing within #(n−4) to #(n−4−T).

Also, if the specific backhaul uplink subframe is the subframe indicated by the third information, and a backhaul downlink subframe, which receives the uplink grant, is the subframe indicated by the second information, the uplink grant is received through a control region of the backhaul downlink subframe.

### Advantageous Effects

According to the embodiments of the present invention, in the wireless communication system, the relay node may effectively transmit an uplink signal to the base station.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

FIG. 1 is a diagram illustrating a network structure of an Evolved Universal Mobile Telecommunications System (E-UMTS), which is an example of a wireless communication system;

FIG. 2 is a diagram illustrating structures of a control plane and a user plane of a radio interface protocol between a user equipment and an E-UTRAN based on the 3GPP radio access network standard;

FIG. 3 is a diagram illustrating physical channels used in a 3GPP system and a general method for transmitting a signal using the physical channels;

FIG. 4 is a diagram illustrating a structure of a radio frame used in an LTE system;

FIG. 5 is a diagram illustrating a structure of a downlink radio frame used in an LTE system;

FIG. 6 is a diagram illustrating a structure of an uplink radio frame used in an LTE system;

FIG. 7 is a diagram illustrating a relay backhaul link and a relay access link in a wireless communication system;

FIG. 8 is a diagram illustrating an example of relay node resource partitioning;

FIG. 9 is a concept diagram illustrating a wireless communication system to which the embodiment of the present invention is applied;

FIG. 10 is a diagram illustrating a method for setting an uplink subframe of a Un interface according to the embodiment of the present invention;

FIG. 11 is a diagram illustrating a method for setting an uplink subframe of a Un interface according to the embodiment of the present invention; and

FIG. 12 is a block diagram illustrating a communication apparatus according to the embodiment of the present invention.

### BEST MODE FOR CARRYING OUT THE INVENTION

Hereinafter, structures, operations, and other features of the present invention will be understood readily by the preferred embodiments of the present invention, examples of which are illustrated in the accompanying drawings. Embodiments described later are examples in which technical features of the present invention are applied to 3GPP system.

Although the embodiment of the present invention will be described based on the LTE system and the LTE-A system in this specification, the LTE system and the LTE-A system are only exemplary, and the embodiment of the present invention may be applied to all communication systems corresponding to the aforementioned definition. Also, although the embodiment of the present invention will be described based on an FDD mode in this specification, the FDD mode is only exemplary, and the embodiment of the present invention may easily be applied to an H-FDD mode or a TDD mode.

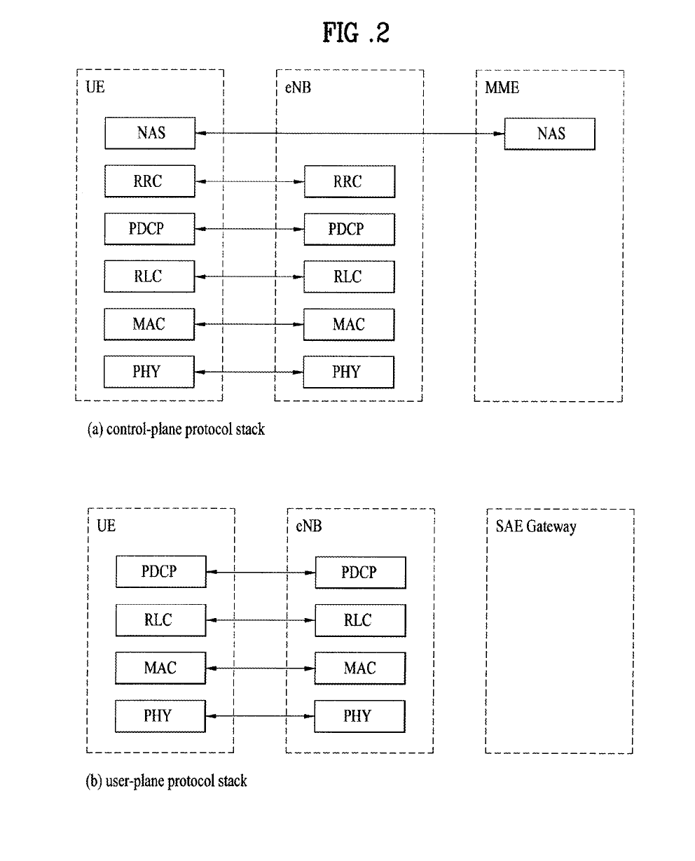

FIG. 2 is a diagram illustrating structures of a control plane and a user plane of a radio interface protocol between a user equipment and E-UTRAN based on the 3GPP radio access network standard. The control plane means a passageway where control messages are transmitted, wherein the control messages are used by the user equipment and the network to manage call. The user plane means a passageway where data generated in an application layer, for example, voice data or Internet packet data are transmitted.

A physical layer as the first layer provides an information transfer service to an upper layer using a physical channel. The physical layer (PHY) is connected to a medium access control (MAC) layer via a transport channel, wherein the medium access control layer is located above the physical layer. Data are transferred between the medium access control layer and the physical layer via the transport channel. Data are transferred between one physical layer of a transmitting side and the other physical layer of a receiving side via the physical channel. The physical channel uses time and frequency as radio resources. In more detail, the physical channel is modulated in accordance with an orthogonal frequency division multiple access (OFDMA) scheme in a downlink, and is modulated in accordance with a single carrier frequency division multiple access (SC-FDMA) scheme in an uplink.

A medium access control (MAC) layer of the second layer provides a service to a radio link control (RLC) layer above the MAC layer via a logical channel. The RLC layer of the second layer supports reliable data transmission. The RLC layer may be implemented as a functional block inside the MAC layer. In order to effectively transmit data using IP packets such as IPv4 or IPv6 within a radio interface having a narrow bandwidth, a packet data convergence protocol (PDCP) layer of the second layer performs header compression to reduce the size of unnecessary control information.

A radio resource control (RRC) layer located on the lowest part of the third layer is defined in the control plane only. The RRC layer is associated with configuration, re-configuration and release of radio bearers (‘RBs’) to be in charge of controlling the logical, transport and physical channels. In this case, the RB means a service provided by the second layer for the data transfer between the user equipment and the network. To this end, the RRC layers of the user equipment and the network exchange RRC message with each other. If the RRC layer of the user equipment is RRC connected with the RRC layer of the network, the user equipment is in an RRC connected mode. If not so, the user equipment is in an RRC idle mode. A non-access stratum (NAS) layer located above the RRC layer performs functions such as session management and mobility management.

One cell constituting a base station eNB is set to one of bandwidths of 1.25, 2.5, 5, 10, 15, and 20 Mhz and provides a downlink or uplink transmission service to several user equipments. At this time, different cells may be set to provide different bandwidths.

As downlink transport channels carrying data from the network to the user equipment, there are provided a broadcast channel (BCH) carrying system information, a paging channel (PCH) carrying paging message, and a downlink shared channel (SCH) carrying user traffic or control messages. Traffic or control messages of a downlink multicast or broadcast service may be transmitted via the downlink SCH or an additional downlink multicast channel (MCH). Meanwhile, as uplink transport channels carrying data from the user equipment to the network, there are provided a random access channel (RACH) carrying an initial control message and an uplink shared channel (UL-SCH) carrying user traffic or control message. As logical channels located above the transport channels and mapped with the transport channels, there are provided a broadcast control channel (BCCH), a paging control channel (PCCH), a common control channel (CCCH), a multicast control channel (MCCH), and a multicast traffic channel (MTCH).

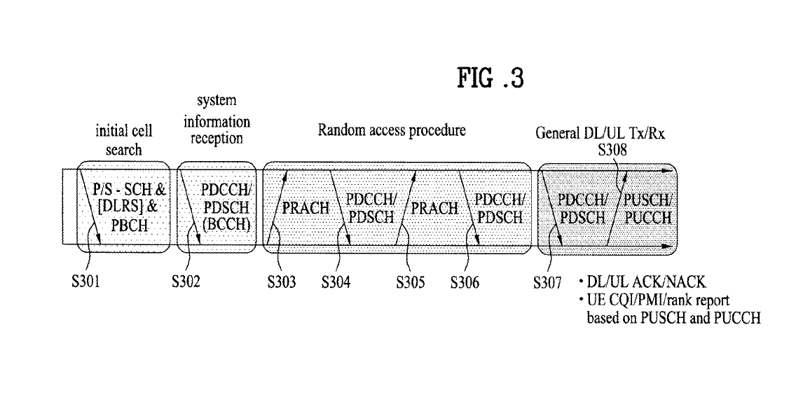

FIG. 3 is a diagram illustrating physical channels used in a 3GPP system and a general method for transmitting a signal using the physical channels.

The user equipment performs initial cell search such as synchronizing with the base station when it newly enters a cell or the power is turned on (S301). To this end, the user equipment may synchronize with the base station by receiving a primary synchronization channel (P-SCH) and a secondary synchronization channel (S-SCH) from the base station, and may acquire information of cell ID, etc. Afterwards, the user equipment may acquire broadcast information within the cell by receiving a physical broadcast channel (PBCH) from the base station. In the mean time, the user equipment may identify the status of a downlink channel by receiving a downlink reference signal (DL RS) at the initial cell search step.

The user equipment which has finished the initial cell search may acquire more detailed system information by receiving a physical downlink shared channel (PDSCH) in accordance with a physical downlink control channel (PDCCH) and information carried in the PDCCH (S302).

In the meantime, if the user equipment initially accesses the base station, or if there is no radio resource for signal transmission, the user equipment may perform a random access procedure (RACH) for the base station (S303 to S306). To this end, the user equipment may transmit a preamble of a specific sequence through a physical random access channel (PRACH) (303 and S305), and may receive a response message to the preamble through the PDCCH and the PDSCH corresponding to the PDCCH (S304 and S306). In case of a contention based RACH, a contention resolution procedure may be performed additionally.

The user equipment which has performed the aforementioned steps may receive the PDCCH/PDSCH (S307) and transmit a physical uplink shared channel (PUSCH) and a physical uplink control channel (PUCCH) (S308), as a general procedure of transmitting uplink/downlink signals. In particular, the user equipment receives downlink control information (DCI) through the PDCCH. In this case, the DCI includes control information such as resource allocation information on the user equipment, and has different formats depending on its usage.

In the meantime, the control information transmitted from the user equipment to the base station or received from the base station to the user equipment through the uplink includes downlink/uplink ACK/NACK signals, a channel quality indicator (CQI), a precoding matrix index (PMI), a scheduling request (SR), and a rank indicator (RI). In case of the 3GPP LTE system, the user equipment may transmit the aforementioned control information such as CQI/PMI/RI through the PUSCH and/or the PUCCH.

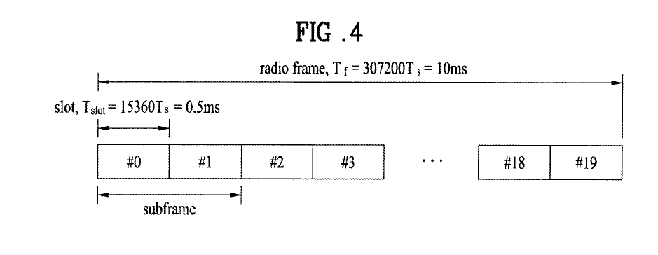

FIG. 4 is a diagram illustrating a structure of a radio frame used in an LTE system.

Referring to FIG. 4, a radio frame has a length of 10 ms (327200×Tₛ) and includes ten (10) subframes of an equal size. Each sub frame has a length of 1 ms and includes two slots. Each slot has a length of 0.5 ms (15360Tₛ). In this case, Tₛ represents a sampling time, and is expressed by Tₛ=1/(15 kHz×2048)=3.2552×10⁻⁸ (about 33 ns). The slot includes a plurality of orthogonal frequency division multiplexing (OFDM) symbols or single carrier-frequency division multiple access (SC-FDMA) symbols in a time domain, and includes a plurality of resource blocks (RBs) in a frequency domain. In the LTE system, one resource block includes twelve (12) subcarriers×seven (or six) OFDM symbols or SC-FDMA symbols. A transmission time interval (TTI), which is a transmission unit time of data, may be determined in a unit of one or more subframes. The aforementioned structure of the radio frame is only exemplary, and various modifications may be made in the number of subframes included in the radio frame or the number of slots included in the subframe, or the number of OFDM symbols or SC-FDMA symbols included in the slot.

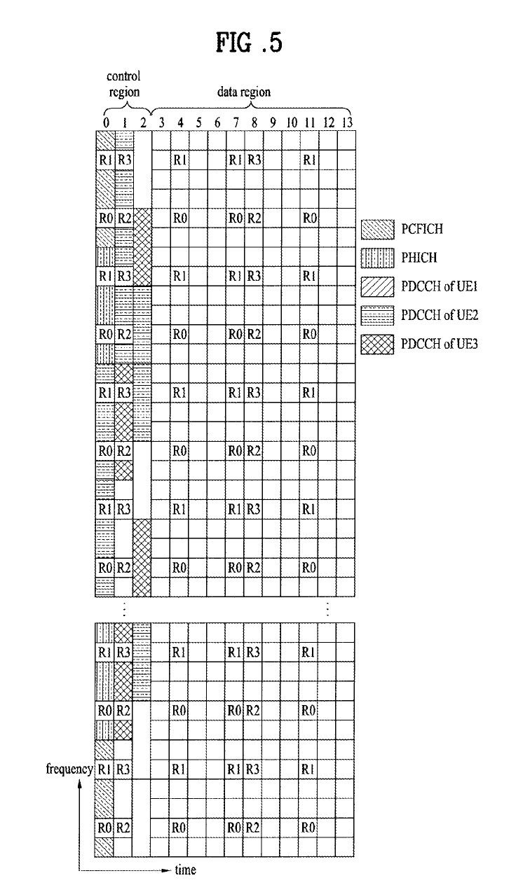

FIG. 5 is a diagram illustrating a control channel included in a control region of one subframe in a downlink radio frame.

Referring to FIG. 5, the subframe includes fourteen (14) OFDM symbols. First one to three OFDM symbols are used as the control region in accordance with subframe configuration, and the other thirteen to eleven OFDM symbols are used as the data region. In FIG. 5, R0 to R3 represent reference signals (RS) (or pilot signals) of antennas 0 to 3. The RS is fixed by a given pattern within the subframe regardless of the control region and the data region. The control channel is allocated to a resource to which the RS is not allocated in the control region, and a traffic channel is also allocated to a resource to which the RS is not allocated in the data region. Examples of the control channel allocated to the control region include a Physical Control Format Indicator Channel (PCFICH), a Physical Hybrid-ARQ Indicator Channel (PHICH), and a Physical Downlink Control Channel (PDCCH).

The PCFICH notifies the user equipment of the number of OFDM symbols used in the PDCCH per subframe. The PCFICH is located in the first OFDM symbol and configured prior to the PHICH and the PDCCH. The PCFICH includes four resource element groups (REG), each REG being distributed in the control region based on cell identity (cell ID). One REG includes four resource elements (REs). The RE represents a minimum physical resource defined by one subcarrier×one OFDM symbol. The PCFICH value indicates a value of 1 to 3 or a value of 2 to 4 depending on a bandwidth, and is modulated by Quadrature Phase Shift Keying (QPSK).

The PHICH is a physical hybrid-automatic repeat and request (HARQ) indicator channel and is used to carry HARQ ACK/NACK signals for uplink transmission. Namely, the PHICH represents a channel where DL ACK/NACK information for UL HARQ is transmitted. The PHICH includes one REG, and is cell-specifically scrambled. The ACK/NACK signals are indicated by 1 bit, and are modulated by binary phase shift keying (BPSK). The modulated ACK/NACK are spread by a spreading factor (SF)=2 or 4. A plurality of PHICHs may be mapped with the same resource and constitute a PHICH group. The number of PHICHs multiplexed in the PHICH group is determined by the number of spreading codes. The PHICH (group) is repeated three times to obtain diversity gain in the frequency domain and/or the time domain.

The PDCCH is allocated to first n number of OFDM symbols of the subframe, wherein n is an integer greater than 1 and is indicated by the PCIFCH. The PDCCH includes one or more CCEs. The PDCCH notifies each user equipment or user equipment group of information related to resource allocation of transport channels, i.e., a paging channel (PCH) and a downlink-shared channel (DL-SCH), uplink scheduling grant, HARQ information, etc. The paging channel (PCH) and the downlink-shared channel (DL-SCH) are transmitted through the PDSCH. Accordingly, the base station and the user equipment respectively transmit and receive data through the PDSCH except for specific control information or specific service data.

Information as to user equipment(s) (one user equipment or a plurality of user equipments) to which data of the PDSCH are transmitted, and information as to how the user equipment(s) receives and decodes PDSCH data are transmitted by being included in the PDCCH. For example, it is assumed that a specific PDCCH is CRC masked with radio network temporary identity (RNTI) called “A,” and information of data transmitted using a radio resource (for example, frequency location) called “B” and transmission format information (for example, transport block size, modulation mode, coding information, etc.) called “C” is transmitted through a specific subframe. In this case, one or more user equipments located in a corresponding cell monitor the PDCCH by using their RNTI information, and if there are one or more user equipments having RNTI called “A”, the user equipments receive the PDCCH, and receive the PDSCH indicated by “B” and “C” through information of the received PDCCH.

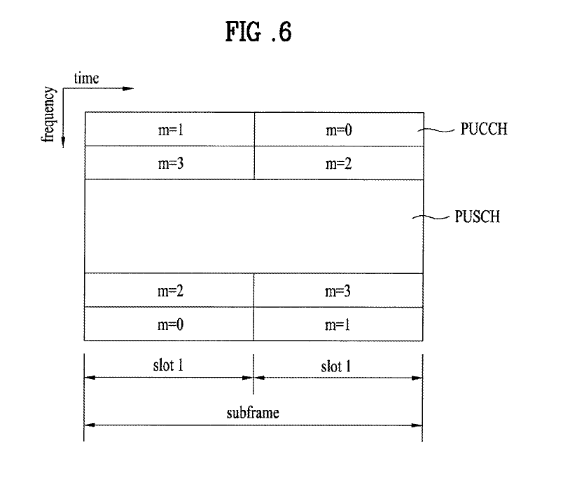

FIG. 6 is a diagram illustrating a structure of an uplink subframe used in an LTE system.

Referring to FIG. 6, the uplink subframe may be divided into a region to which a physical uplink control channel (PUCCH) carrying control information is allocated, and a region to which a physical uplink shared channel (PUSCH) carrying user data is allocated. The center part of the subframe is allocated to the PUSCH, and both parts of the data region in the frequency domain are allocated to the PUCCH. Examples of the control information transmitted on the PUCCH include ACK/NACK used for HARQ, a channel quality indicator (CQI) indicating the status of a downlink channel, a rank indicator (RI) for MIMO, and a scheduling request (SR) corresponding to uplink resource allocation request. The PUCCH for one user equipment uses one resource block that occupies different frequencies in each slot within the subframe. Namely, two resource blocks allocated to the PUCCH undergo frequency hopping in the boundary of the slots. Particularly, FIG. 6 exemplarily illustrates that PUCCH of m=0, PUCCH of m=1, PUCCH of m=2, and PUCCH of m=3 are allocated to the subframe.

Meanwhile, when the channel status between the base station and the user equipment is not good, a relay node (RN) is provided between the base station and the user equipment, whereby a radio channel having the more excellent channel status may be provided to the user equipment. Also, a relay node is provided in a cell edge zone having a poor channel status from the base station, whereby a data channel may be provided at higher speed, and a cell service zone may be extended. In this way, the technology of the relay node has been introduced to remove a radio wave shadow zone in a wireless communication system, and is widely used at present.

The technology of the relay node is being recently developed to more intelligent type than a function of a repeater that simply amplifies a signal and transmits the amplified signal. Moreover, the technology of the relay node reduces the extension cost for installation of base stations and the maintenance cost of a backhaul network in a next generation mobile communication system and at the same time is necessarily required to extend service coverage and improve a data processing rate. As the technology of the relay node is gradually developed, it is required that a new wireless communication system should support a relay node used in the related art wireless communication system.

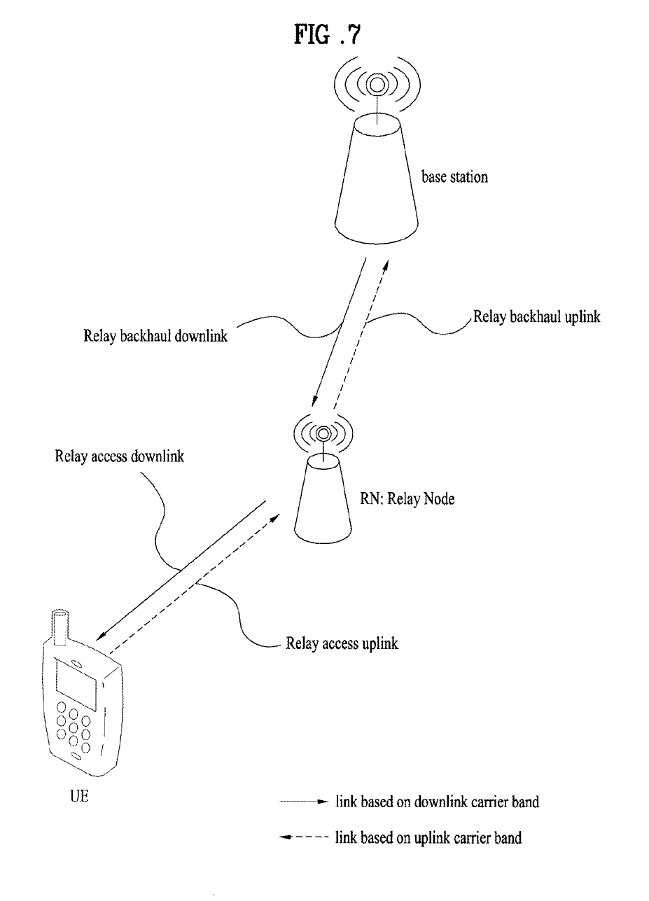

FIG. 7 is a diagram illustrating a configuration of a relay backhaul link and a relay access link in a wireless communication system.

Referring to FIG. 7, as the relay node is introduced for forwarding for link connection between the base station and the user equipment in the 3GPP LTE system, two types of links having different attributes are applied to each of uplink and downlink carrier frequency bands. A connection link portion established between the base station and the relay node will be defined as a backhaul link. If transmission of the backhaul link is performed using resources of downlink frequency band (in case of FDD) or resources of downlink subframe (in case of TDD), the backhaul link may be expressed as a backhaul downlink. If transmission of the backhaul link is performed using resources of uplink frequency band (in case of FDD) or resources of uplink subframe (in case of TDD), the backhaul link may be expressed as a backhaul uplink.

On the other hand, a connection link portion between the relay node and a series of user equipments will be defined as a relay access link. If transmission of the relay access link is performed using resources of downlink frequency band (in case of FDD) or resources of downlink subframe (in case of TDD), the relay access link may be expressed as an access downlink. If transmission of the relay access link is performed using resources of uplink frequency band (in case of FDD) or resources of uplink subframe (in case of TDD), the relay access link may be expressed as an access uplink.

The relay node (RN) may receive information from the base station through the relay backhaul downlink, and may transmit information to the base station through the relay backhaul uplink. Also, the relay node may transmit information to the user equipment through the relay access downlink, and may receive information from the user equipment through the relay access uplink.

Meanwhile, in respect of band (or spectrum) of the relay node, if the backhaul link is operated in the same frequency band as that of the access link, the operation will be referred to as ‘in-band’ operation. If the backhaul link is operated in the frequency band different from that of the access link, the operation will be referred to as ‘out-band’ operation. In both in-band and out-band, a user equipment (hereinafter, referred to as ‘legacy user equipment’) operated in accordance with the existing LTE system (for example, release-8) should access a donor cell.

The relay node may be classified into a transparent relay node and a non-transparent relay node depending on whether the user equipment recognizes the relay node. The transparent relay node means that it fails to recognize whether the user equipment performs communication with the network through the relay node. The non-transparent relay node means that it recognizes whether the user equipment performs communication with the network through the relay node.

In respect of control of the relay node, the relay node may be classified into a relay node configured as a part of a donor cell and a relay node that controls a cell by itself.

Although the relay node configured as a part of a donor cell has relay node ID, it does not have its own cell identity. If at least a part of radio resource management (RRM) is controlled by a base station to which a donor cell belongs (even though the other parts of the RRM are located in the relay node), it will be referred to as a relay node configured as a part of the donor cell. Preferably, this relay node may support the legacy user equipment. For example, examples of this type relay node include smart repeaters, decode-and-forward relays, L2 (second layer) relay nodes, and type-2 relay node.

The relay node that controls a cell by itself controls one cell or several cells, and a unique physical layer cell identity is provided to each of cells controlled by the relay node. Also, the same RRM mechanism may be used for each of the cells. In view of the user equipment, there is no difference between access to a cell controlled by the relay node and access to a cell controlled by the base station. Preferably, the cell controlled by the relay node may support the legacy user equipment. For example, examples of this type relay node include a self-backhauling relay node, L3 (third layer) relay node, a type-1 relay node and a type-1a relay node.

The type-1 relay node is an in-band relay node and controls a plurality of cells, each of which is regarded as a separate cell differentiated from the donor cell in view of the user equipment. Also, the plurality of cells respectively have their physical cell ID (defined in LTE release-8), and the relay node may transmit its synchronization channel, reference signal, etc. In case of single-cell operation, the user equipment directly receives scheduling information and HARQ feedback from the relay node and transmits its control channel (scheduling request (SR), CQI, ACK/NACK, etc.) to the relay node. Also, in view of the legacy user equipments (operated in accordance with the LTE release-8 system), the type-1 relay node is regarded as a legacy base station (operated in accordance with the LTE release-8 system). Namely, the type-1 relay node has backward compatibility. Meanwhile, in view of the user equipments operated in accordance with the LTE-A system, the type-1 relay node is regarded as a base station different from the legacy base station, whereby throughput improvement may be provided.

The type-1a relay node has the same features as those of the aforementioned type-1 relay node in addition to out-band operation. The type-1a relay node may be configured in such a manner that its operation is less affected or not affected by the operation of L1 (first layer) operation.

The type-2 relay node is an in-band relay node, and does not have separate physical cell ID, whereby a new cell is not formed. The type-2 relay node is transparent with respect to the legacy user equipment, and the legacy user equipment fails to recognize the presence of the type-2 relay node. Although the type-2 relay node may transmit the PDSCH, it does not transmit CRS and PDCCH.

Meanwhile, in order that the relay node is operated in accordance with in-band, some resources in time-frequency domains should be reserved for the backhaul link, and may be established so as not to be used for the access link. This will be referred to as resource partitioning.

The general principle in resource partitioning of the relay node will be described as follows. The backhaul downlink and the access downlink may be multiplexed on one carrier frequency in accordance with the TDM mode (namely, only one of the backhaul downlink and the access downlink is enabled for a specific time). Similarly, the backhaul uplink and the access uplink may be multiplexed on one carrier frequency in accordance with the TDM mode (namely, only one of the backhaul uplink and the access uplink is enabled for a specific time).

According to backhaul link multiplexing in the FDD mode, backhaul downlink transmission is performed in a downlink frequency band, and backhaul uplink transmission is performed in an uplink frequency band. According to backhaul link multiplexing in the TDD mode, backhaul downlink transmission is performed in a downlink subframe of the base station and the relay node, and backhaul uplink transmission is performed in an uplink subframe of the base station and the relay node.

In case of the in-band relay node, if backhaul downlink reception from the base station and access downlink transmission to the user equipment are performed in a predetermined frequency band at the same time, a signal transmitted from a transmitter of the relay node may be received in a receiver of the relay node, whereby signal interference or RF jamming may occur in RF front-end of the relay node. Similarly, if access uplink reception from the user equipment and backhaul uplink transmission to the base station are performed in a predetermined frequency band at the same time, signal interference may occur in RF front-end of the relay node. Accordingly, it is difficult to perform simultaneous transmission and reception in one frequency band of the relay node unless sufficient separation (for example, a transmitting antenna and a receiving antenna are locally spaced apart from each other (for example, the transmitting antenna is installed on the ground and the receiving antenna is installed below the ground)) between the receiving signal and the transmitting signal is provided.

One solution for solving the problem of signal interference is that the relay node is operated so as not to transmit a signal to the user equipment when receiving a signal from a donor cell. In other words, a gap occurs in transmission from the relay node to the user equipment, and the user equipment (including legacy user equipment) may be configured so as not to expect any transmission from the relay node for the gap. The gap may be configured by a multicast broadcast single frequency network (MBSFN) subframe.

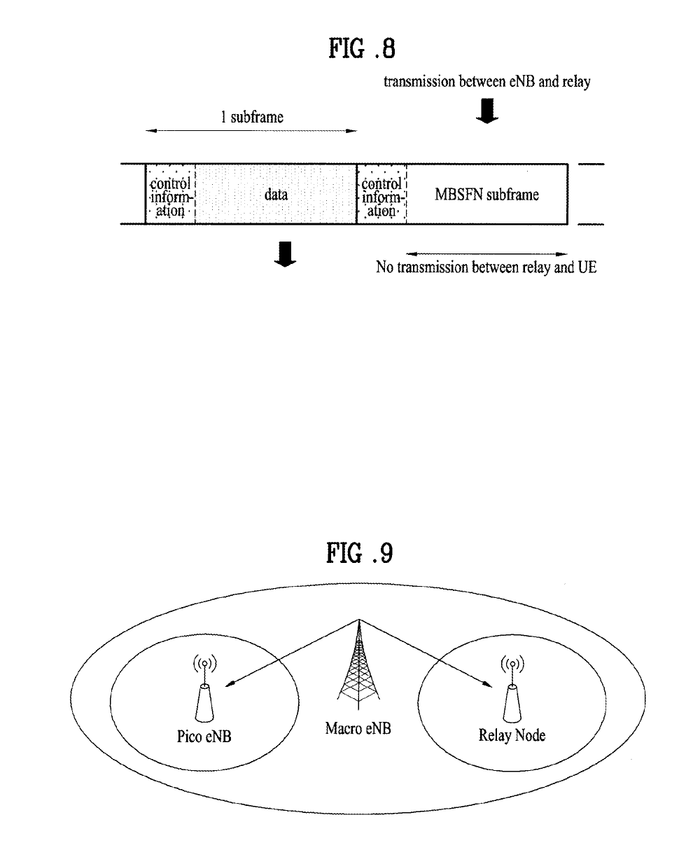

FIG. 8 is a diagram illustrating an example of resource partitioning of a relay node.

In FIG. 8, the first subframe is a general subframe, and a downlink (i.e., access downlink) control signal and data are transmitted from the relay node to the user equipment. The second subframe is an MBSFN subframe, and a control signal is transmitted from the relay node to the user equipment in a control region of a downlink subframe but no signal is transmitted from the relay node to the user equipment in other regions of the downlink subframe. Since the legacy user equipment expects transmission of a physical downlink control channel (PDCCH) from all downlink subframes (namely, since the relay node needs to support legacy user equipments in its zone to receive a PDCCH per subframe and perform a measurement function), for normal operation of the legacy user equipment, it is required to transmit the PDCCH from all the downlink subframes. Accordingly, even on a subframe (second subframe) configured for downlink (i.e., backhaul downlink) transmission from the base station to the relay node, the relay node needs to perform access downlink transmission not backhaul downlink reception, for first N (N=1, 2 or 3) OFDM symbol intervals of the subframe. Since the PDCCH is transmitted from the relay node to the user equipment, backward compatibility for the legacy user equipment, which is served by the relay node, may be provided in the control region of the second subframe. The relay node may receive transmission from the base station in the other regions of the second subframe for the time when no transmission from the relay node to the user equipment is performed. Accordingly, this resource partitioning allows access downlink transmission and backhaul downlink reception not to be performed in the in-band relay node at the same time.

The second subframe which is the MBSFN subframe will be described in more detail. The control region of the second subframe may be regarded as a relay node non-hearing interval. The relay node non-hearing interval means that the relay node does not receive a backhaul downlink signal but transmits an access downlink signal. This interval may be set to 1, 2, or 3 OFDM length as described above. For the relay node non-hearing interval, the relay node performs access downlink transmission to the user equipment, and receives backhaul downlink from the base station in the other regions. At this time, since the relay node cannot perform transmission and reception in the same frequency band at the same time, it requires time to switch a transmission mode of the relay node to a reception mode of the relay node. Accordingly, a guard time (GT) is required for first some interval of a backhaul downlink receiving zone, so that the relay node performs transmission/reception mode switching. Similarly, even in the case that the relay node is operated to receive a backhaul downlink from the base station and transmit an access downlink to the user equipment, a guard time (GT) for reception/transmission mode switching of the relay node may be set. The length of the guard time may be given by a value of a time domain. For example, the length of the guard time may be given by k (k≧1) time sample (Ts) values, or one or more OFDM symbol lengths. Also, the guard time of the last portion of the subframe may not be defined, or may not be set either if backhaul downlink subframes of the relay node are set continuously or depending on timing alignment of predetermined subframes. The guard time may be defined in a frequency domain only set for backhaul downlink subframe transmission, to maintain backward compatibility (if the guard time is set for the access downlink interval, the legacy user equipment cannot be supported). For the backhaul downlink reception interval except for the guard time, the relay node may receive the PDCCH and the PDSCH from the base station. The PDCCH and the PDSCH may be referred to as a relay-PDCCH (R-PDCCH) and a relay-PDSCH (R-PDSCH) in view of physical channels dedicated for the relay node.

Also, a macro cell notifies the relay node of Un DL subframe configuration for a Un interface, that is, a backhaul link between the macro cell and the relay node, as 8-bit sized bitmap information through RRC layer signaling at a period of 8 ms,

However, downlink subframe indexes 0, 4, 5 and 9 in the FDD system or downlink subframe indexes 0, 1, 5 and 6 in the TDD system are the subframes designated for communication through an access link between the relay node and the user equipment R-UE, that is, an Uu interface, wherein the user equipment R-UE performs communication with the relay node. The downlink subframes indexes 0, 4, 5 and 9 in the FDD system and the downlink subframe indexes 0, 1, 5 and 6 in the TDD system cannot be used as those for a backhaul link between the macro cell and the relay node, that is, the Un interface.

The present invention relates to a method for transmitting an uplink signal from the relay node to the base station if a pico cell and the relay node coexist within coverage of one macro cell in the FDD system. In particular, the present invention defines signaling configuration for efficiently supporting an uplink-heavy status corresponding to a case where an uplink signal is dominant in the backhaul link of the Un interface between the macro cell and the relay node, and an operation of the relay node based on the signaling configuration. Although the present invention discloses the operation between the relay node and the base station in the following description, the present invention may be applied to the operation between the base station and the user equipment or between the relay node and the user equipment. Also, the present invention may be applied to the TDD system as well as the FDD system.

FIG. 9 is a concept diagram illustrating a wireless communication system to which the embodiment of the present invention is applied. In particular, FIG. 9 illustrates a case where a pico cell and a relay node coexist within coverage of one macro cell. Unlike a femto cell that generally provides services for limited subscribers, the pico cell provides services for open type cells, that is, all subscribers, and is connected with the macro cell through X2 interface.

Referring to FIG. 9, in order to reduce interference of the pico cell, which may occur due to downlink transmission of the macro cell, a part of downlink subframes is designated as an almost blank subframe (ABS). In the FDD system, to designate the ABS, ABS configuration, which includes pattern information, is signaled at a period of 40 ms, and information for ABS configuration information is provided in the form of bitmap of a total of 40 bits. For reference, in the TDD system, ABS configuration is signaled at a period of 70 ms in UL/DL configuration 0, signaled at a period of 20 ms in UL/DL configurations 1 to 5, and signaled at a period of 60 ms in UL/DL configuration 6.

In the meantime, it is generally set that a common reference signal (CRS) for channel measurement is only transmitted for the downlink subframe designated as the ABS. Also, if a location of the downlink subframe designated as the ABS is overlapped with a location of a subframe to which a primary synchronization signal (PSS), a secondary synchronization signal (SSS), a physical broadcast channel, a system information block type 1 (SIB Type 1), a paging signal, and a positioning reference signal are transmitted, these signals may be transmitted for even the downlink subframe designated as the ABS.

Meanwhile, in the present invention, it is assumed that a multi-subframe scheduling scheme is applied to an FDD system, which enables an asymmetric DL-UL subframe operation, for efficient signal transmission when an uplink signal is dominant in a backhaul link. In this case, the multi-subframe scheduling scheme means that scheduling information of two or more uplink subframes, that is, uplink grant is transmitted for one downlink subframe.

Also, in the present invention, it is assumed that 1) Un DL subframe configuration information for Un interface, which is the 8-bit sized bitmap information, 2) ABS configuration information, which is the 40-bit sized bitmap information, and 3) additional UL subframe configuration information designated as UL standalone subframe in the Un interface which is a backhaul link are signaled as bitmap information of a total of 40 bits.

Hereinafter, the operation of the relay node that has received the configuration information of 1) to 3) as above from the macro cell will be defined as follows.

(1) A downlink subframe, for which an uplink grant for the uplink subframe of which index is #n, among the uplink subframes designated by the additional uplink subframe configuration information, may be transmitted, is considered within a previously set time range T only. In other words, if T=N (where, N is a positive integer not 0) is set, the downlink subframe for decoding the uplink grant may have indexes such as #(n−4), #(n−4−1), . . . , #(n−4−(N−1)), #(n−4−N) or #(n−4−1), . . . , #(n−4−(N−1)), #(n−4−N). Also, T may be set to a value of 0, and in this case, the uplink grant may be transmitted for the downlink subframe index #(n−4) only.

For example, if T=2 is set, it is regarded that the uplink grant for the uplink subframe of which index is #n may be transmitted for the downlink subframes only of which indexes are #(n−4), #(n−5), and #(n−6).

Also, it is preferable, but not limited, that the previously set time range T is transmitted from the macro cell to the relay node through upper layer signaling such as RRC signaling. The previously set time range T may be signaled dynamically through the PDCCH.

In this case, among the downlink subframes belonging to the previously set time range T, the downlink subframe, for which an uplink grant for the uplink subframe having index #n may be transmitted, should be the subframe not the downlink subframe (for example, subframe of which indexes are 0, 4, 5 and 9 in the FDD system or subframe of which indexes are 0, 1, 5 and 6 in the TDD system) of the Uu interface among the downlink subframes designated by the configuration information of 1), that is, Un DL subframe configuration information which is 8-bit sized bitmap information, and should also be the downlink subframe closest to the uplink subframe of which index is #n.

Accordingly, the downlink subframe, for which an uplink grant for the uplink subframe having index #n may be transmitted, may be one of ‘Un interface downlink subframe and non-ABS (hereinafter, subframe type 1)’ and ‘Un interface downlink subframe and ABS (hereinafter, subframe type 2)’. Also, the downlink subframe, for which the uplink grant may be transmitted, may be limited to the downlink subframe of subframe type 1.

(2) If downlink subframe configuration and ABS configuration of the Un interface are all set to 1 at the location of one downlink subframe, it is assumed that the downlink subframe is regarded as ABS not the downlink subframe of the Un interface, and a primary synchronization signal (PSS), a secondary synchronization signal (SSS), a physical broadcast channel, a system information block type 1 (SIB Type 1), a paging signal and a positioning reference signal may be transmitted as described above.

However, if downlink subframe configuration and ABS configuration of the Un interface are all set to 1 at the location of one downlink subframe, that is, even in case of subframe type 2, it is assumed that the uplink grant may be transmitted for the downlink subframe of the Un interface, for which the uplink grant for the uplink subframe having index #n designated by configuration of 3), that is, additional UL subframe configuration is transmitted.

For example, in the subframe type 1, the R-PDCCH, which includes the uplink grant, may be transmitted through the data region of the downlink subframe, and in the subframe type 2, the uplink grant may be transmitted through the control region of the downlink subframe. Also, if the subframe type 2 is intended to transmit the uplink grant for the uplink subframe of index #n designated by the additional UL subframe configuration, the R-PDCCH, which includes the uplink grant, may be transmitted as an exception of the ABS.

(3) Finally, if the downlink subframe, which satisfies the condition of (1) for transmission of the uplink grant for the uplink subframe of index #n designated by the additional UL subframe configuration, does not exist, the relay node regards that the macro cell causes a configuration error, and does not expect to receive UL grant linked to the subframe of index #n designated by the additional uplink subframe configuration.

Hereinafter, the uplink subframe configuration will be described in more detail with reference to the drawings.

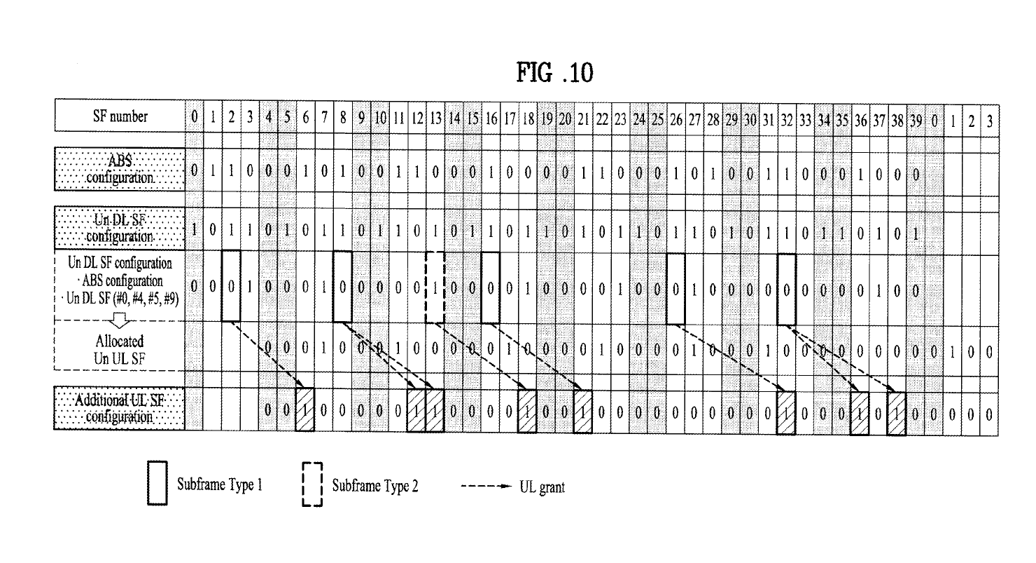

FIG. 10 is a diagram illustrating a method for setting an uplink subframe of a Un interface according to the embodiment of the present invention. In particular, it is assumed in FIG. 10 that the previously set time range T is 2 in the FDD system. Accordingly, indexes of the Un interface downlink subframe, for which the uplink grant for the UL subframe #n designated in accordance with the additional uplink subframe configuration information is transmitted, may be #(n−4), #(n−5), and #(n−6).

Referring to FIG. 10, 1) “1 0 1 1 0 1 0 1” as the configuration information of the downlink subframe for the 8-bit sized Un interface, 2) “0 1 1 0 0 0 1 0 1 0 0 1 1 0 0 0 1 0 0 0 0 1 1 0 0 0 1 0 1 0 0 1 1 0 0 0 1 0 0 0” as the ABS configuration information which is the 40-bit sized bitmap information, and 3) “0 0 1 0 0 0 0 0 1 1 0 0 0 0 1 0 0 1 0 0 0 0 0 0 0 0 0 0 1 0 0 0 1 0 1 0 0 0 0 0” as 40-bit sized additional uplink subframe configuration information are signaled from the macro cell to the relay node. In this case, the relay node may identify the downlink subframe of the Un interface, for which the uplink grant of the uplink subframe #n of the Un interface is transmitted, on the basis of the configuration information of 1) to 3).

For example, in FIG. 10, [Un DL SF configuration-ABS configuration-Uu DL SF (#0, #4, #5, #9)] is the bitmap of downlink subframes of the Un interface, which remains after ABS configuration which is the 40-bit sized bitmap of 2) and Uu interface downlink subframes (index #0, #4, #5, #9) are removed from the bitmap of 40 bits obtained by repeating the 8-bit sized bitmap information of 1) five times.

Also, in FIG. 10, [Allocated Un UL SF] shows the bitmap for the uplink subframes of the Un interface, which may be generated under the assumption that the uplink grant is transmitted for the downlink subframes of the Un interface set by [Un DL SF configuration-ABS configuration-Uu DL SF (#0, #4, #5, #9)]. In particular, [Allocated Un UL SF] may be configured in such a manner that [Un DL SF configuration-ABS configuration-Uu DL SF (#0, #4, #5, #9)] is delayed as much as 4 subframes.

Accordingly, the downlink subframes of the Un interface, for which the uplink grant for the uplink subframes designated by the additional uplink subframe configuration information is transmitted, may be indexes #2, #8, #13, #16, #26, and #32 as shown in FIG. 10. Among these downlink subframes, the subframe of index #13 is not the subframe type 1, that is, ABS.

However, the subframes of indexes #2, #8, #16, #26, and #32 correspond to the subframe type 2, that is, ABS, and may enable R-PDCCH transmission for the uplink grant as described above. Of course, R-PDCCH transmission for the uplink grant may be performed even for a backhaul downlink subframe, which satisfies the condition of (1), as well as the uplink subframe of index #n designated by the additional uplink subframe configuration.

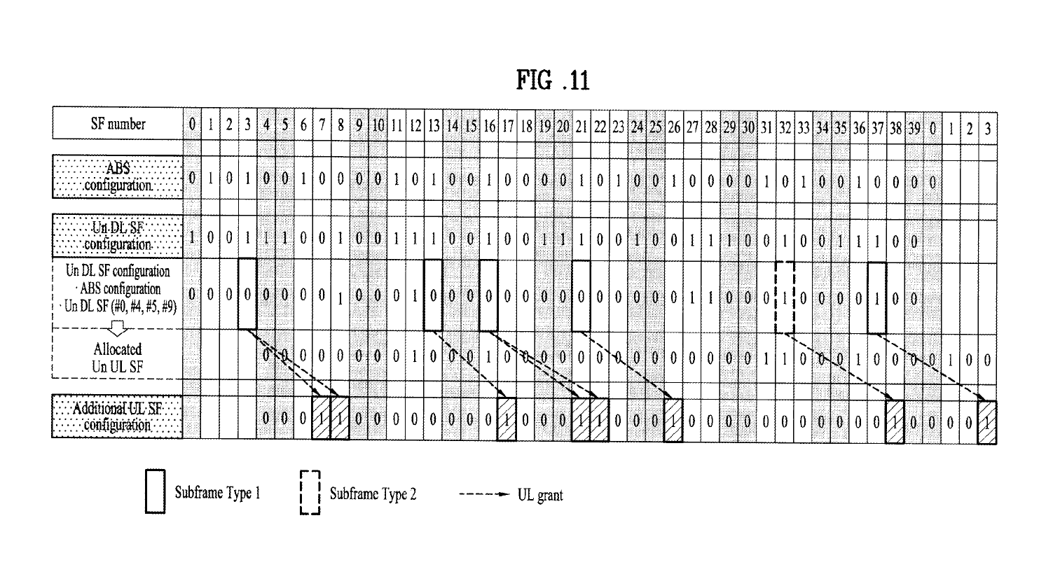

FIG. 11 is a diagram illustrating a method for setting an uplink subframe of a Un interface according to the embodiment of the present invention. In the same manner as FIG. 10, it is assumed in FIG. 11 that the previously set time range T is 2.

Referring to FIG. 11, 1) “1 0 0 1 1 1 0 0” as configuration information of the downlink subframe for the 8-bit sized Un interface, 2) “0 1 0 1 0 0 1 0 0 0 0 1 0 1 0 0 1 0 0 0 0 1 0 1 0 0 1 0 0 0 0 1 0 1 0 0 1 0 0 0” as the ABS configuration information which is the 40-bit sized bitmap information, and 3) “0 0 0 1 1 0 0 0 0 0 0 0 0 1 0 0 0 1 1 0 0 0 1 0 0 0 0 0 0 0 0 0 0 0 1 0 0 0 0 1” as 40-bit sized additional uplink subframe configuration information are signaled from the macro cell to the relay node.

Accordingly, the downlink subframes of the Un interface, for which the uplink grant for the uplink subframes designated by the additional uplink subframe configuration information is transmitted, may be indexes #3, #13, #16, #21, #32, and #37 as shown in FIG. 11. Among these downlink subframes, the subframes of indexes #32 and #37 are not the subframe type 1, that is, ABS.

However, the subframes of indexes #3, #13, #16 and #21 correspond to the subframe type 2, that is, ABS, and may enable R-PDCCH transmission for the uplink grant as described above.

Of course, R-PDCCH transmission for the uplink grant may be performed even for a backhaul downlink subframe, which satisfies the condition of (1), as well as the uplink subframe of index #n designated by the additional uplink subframe configuration.

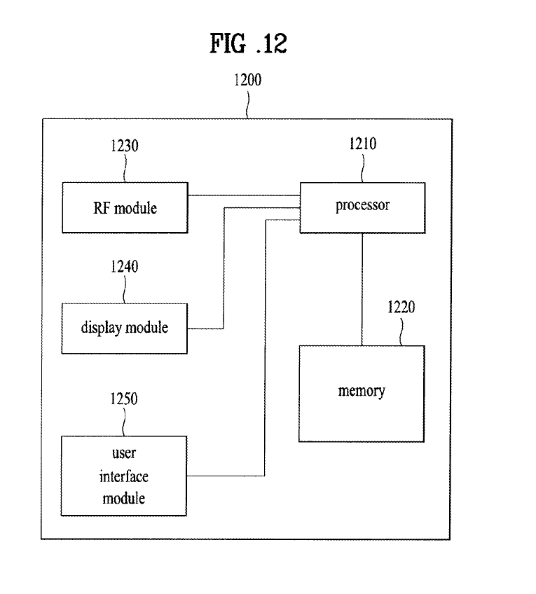

FIG. 12 is a block diagram illustrating a communication apparatus according to the embodiment of the present invention.

Referring to FIG. 12, the communication apparatus 1200 includes a processor 1210, a memory 1220, a radio frequency (RF) module 1230, a display module 1240, and a user interface module 1250.

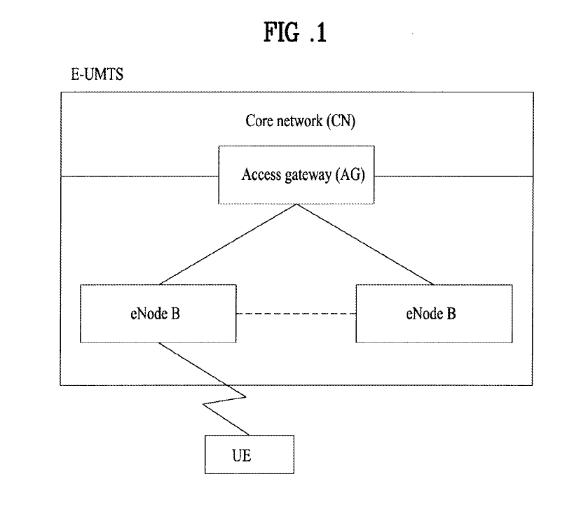

The communication apparatus 1200 is illustrated for convenience of description, and some of its modules may be omitted. Also, the communication apparatus 1200 may further include necessary modules. Moreover, some modules of the communication apparatus 1200 may be divided into segmented modules. The processor 1210 is configured to perform the operation according to the embodiment of the present invention illustrated with reference to the drawings. In more detail, a detailed operation of the processor 1210 will be understood with reference to the disclosure described with reference to FIG. 1 to FIG. 11.

The memory 1220 is connected with the processor 1210 and stores an operating system, an application, a program code, and data therein. The RF module 1230 is connected with the processor 1210 and converts a baseband signal to a radio signal or vice versa. To this end, the RF module 1230 performs analog conversion, amplification, filtering and frequency uplink conversion, or their reverse processes. The display module 1240 is connected with the processor 1210 and displays various kinds of information. Examples of the display module 1240 include, but not limited to, a liquid crystal display (LCD), a light emitting diode (LED), and an organic light emitting diode (OLED). The user interface module 1250 is connected with the processor 1210, and may be configured by combination of well known user interfaces such as keypad and touch screen.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention have been described based on the data transmission and reception between the relay node and the base station. A specific operation which has been described as being performed by the base station may be performed by an upper node of the base station as the case may be. In other words, it will be apparent that various operations performed for communication with the user equipment in the network which includes a plurality of network nodes along with the base station can be performed by the base station or network nodes other than the base station. The base station may be replaced with terms such as a fixed station, Node B, eNode B (eNB), and access point.

The embodiments according to the present invention may be implemented by various means, for example, hardware, firmware, software, or their combination. If the embodiment according to the present invention is implemented by hardware, the embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the embodiment of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

Although the method for transmitting an uplink signal from a relay node to a base station in a wireless communication system and the apparatus for the same have been described based on the 3GPP LTE system, they may be applied to various wireless communication systems in addition to the 3GPP LTE system.

1. A method for transmitting an uplink signal from a relay node to a base station in a wireless communication system, the method comprising the steps of:
configuring backhaul uplink subframes on the basis of a plurality of kinds of subframe configuration information received from the base station; and
transmitting the uplink signal to the base station on the basis of an uplink grant for a specific one of the configured backhaul uplink subframes,
wherein the uplink grant is received for a backhaul downlink subframe which exists within a previously set period of time (T) from the specific backhaul uplink subframe, and the backhaul downlink subframes is not an access downlink subframe.

2. The method according to claim 1, wherein the plurality of kinds of subframe configuration information includes first information on the backhaul downlink subframes configured by the base station, second information on subframes for removing interference occurring in a pico cell, and third information on UL standalone subframes configured by the base station.

3. The method according to claim 2, wherein the configured backhaul uplink subframes include subframes delayed as much as 4 subframe unit after the access downlink subframes and subframes indicated by the second information are excluded from subframes indicated by the first information, and further include subframes indicated by the third information.

4. The method according to claim 3, wherein the access downlink subframes are those of indexes #(0), #(4), #(5) and #(9).

5. The method according to claim 2, wherein, if the specific backhaul uplink subframe is the subframe of index #(n) indicated by the third information, the uplink grant is transmitted from the base station to the relay node for a backhaul downlink subframe existing within #(n−4) to #(n−4−T).

6. The method according to claim 2, wherein, if the specific backhaul uplink subframe is the subframe indicated by the third information, and a backhaul downlink subframe, which receives the uplink grant, is the subframe indicated by the second information, the uplink grant is received through a control region of the backhaul downlink subframe.

7. A relay node in a wireless communication system, the relay node comprising:
a reception module configured to receive a plurality of kinds of subframe configuration information received from a base station;
a processor configured to configure backhaul uplink subframes on the basis of the plurality of kinds of subframe configuration information; and
a transmission module configured to transmit an uplink signal to the base station on the basis of an uplink grant for a specific one of the configured backhaul uplink subframes,
wherein the uplink grant is received for a backhaul downlink subframe which exists within a previously set period of time (T) from the specific backhaul uplink subframe, and the backhaul downlink subframes is not an access downlink subframe.

8. The relay node according to claim 7, wherein the plurality of kinds of subframe configuration information includes first information on the backhaul downlink subframes configured by the base station, second information on subframes for removing interference occurring in a pico cell, and third information on UL standalone subframes configured by the base station.

9. The relay node according to claim 8, wherein the configured backhaul uplink subframes include subframes delayed as much as 4 subframe unit after the access downlink subframes and subframes indicated by the second information are excluded from subframes indicated by the first information, and further include subframes indicated by the third information.

10. The relay node according to claim 9, wherein the access downlink subframes are those of indexes #(0), #(4), #(5) and #(9).

11. The relay node according to claim 8, wherein, if the specific backhaul uplink subframe is the subframe of index #(n) indicated by the third information, the uplink grant is transmitted from the base station to the relay node for a backhaul downlink subframe existing within #(n−4) to #(n−4−T).

12. The relay node according to claim 8, wherein, if the specific backhaul uplink subframe is the subframe indicated by the third information, and a backhaul downlink subframe, which receives the uplink grant, is the subframe indicated by the second information, the uplink grant is received through a control region of the backhaul downlink subframe.
